(19) United States
(12) Patent Application Publication
(10) Pub. No.: US 2004/0088229 A1
(43) Pub. Date: May 6, 2004

(54) Multi-user light directed inventory system

(76) Inventor: Yongjie Xu, Richmond, VA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/287,540

(22) Filed: Nov. 5, 2002

(51) Int. Cl. G06F 17/60

(52) U.S. Cl. 705/28

(57) ABSTRACT

A multi-user light directed inventory system uses a light module having a plurality of light indicia each associated with either an inventory specialist or an order. The plurality of light indicia allow multiple inventory specialists to concurrently service multiple orders. Alternatively, the plurality of light indicia allow multiple orders to be concurrently serviced by a single inventory specialist. The light module may also include a quantity indicator either separate from or integral with the plurality of light indicia.

### BACKGROUND

1. Field of the Invention

The present invention relates generally to an inventory system and more particularly to a multi-user light directed inventory system.

2. Discussion of the Related Art

Light directed inventory systems are common when a large number of inventory items is required to fill a order (e.g, a customer order, a parts list for assembly, a stocking list, etc.). Conventional light directed inventory systems include a host computer, in some instances a plurality of zone and/or subcontrollers, and a plurality of light directed modules. The individual components of these conventional systems may be coupled to one another using various wired or wireless technologies. The light directed inventory system is integrated with storage bins or locations that store the various inventory items. Typically, one of the light directed modules is co-located with each individual storage bin for a particular inventory item.

In these conventional systems, an order is received by the host computer. The host computer organizes the order according to specific light directed modules associated with the inventory items on the list. The host computer forwards information, and in some instances, quantity information, to one or more zone controllers and/or subcontrollers corresponding to the individual light directed modules that are associated with the inventory items in the order. The zone controller or subcontroller forwards the quantity information to each of the corresponding light directed modules. Each of the corresponding light directed modules will in turn display the number of inventory items to service (i.e., to pick from or put into) that particular storage bin.

The light directed modules direct an inventory specialist how to complete the order by identifying each storage bin and the quantity of inventory items to be serviced with that storage bin. After servicing the proper quantity at each storage bin, the inventory specialist indicates completion at each the light directed module (e.g., by pressing a task complete button, etc.)

The host computer checks each of the corresponding light directed modules associated with the order to ensure that all inventory items have been serviced for that order. When all storage bins have been serviced, the host computer will be ready for another order.

One problem associated with conventional light directed inventory systems is that orders must be serviced sequentially. In other words, because multiple orders cannot be serviced at the same storage bin simultaneously, multiple orders cannot be serviced in parallel, either by multiple inventory specialists or by single inventory specialists servicing multiple orders. Thus, the speed at which orders can be serviced using a conventional system depends on the speed of the slowest inventory specialist.

Thus, what is needed is a multi-user light directed inventory system to overcome these and other associated problems.

### SUMMARY OF THE INVENTION

The present invention provides a multi-user light directed inventory system. Light directed inventory systems assist inventory specialists with filling or servicing orders. Each order includes one or more inventory items that must either be stocked to or retrieved from a storage bin. So that the inventory specialists do not waste time manually trying to match identification numbers associated with the inventory items in the order with those found on the storage bins, the present invention directs inventory specialists to the storage bins where the inventory items required to service the order are located without the inventory specialist having to match any identification numbers.

In order to direct inventory specialists to the appropriate storage bins (and the inventory items stored therein), a host computer communicates with several light modules, each located at one of the storage bin. The host computer keeps track of the location of the storage bins for the inventory items based on an address of each of the light directed modules. When the host computer receives an order, the host computer provides information to each of the light modules associated with the inventory items in the order thereby causing the light module to provide some visual stimulation (typically light) to the inventory specialist. The inventory specialist can quickly fill the order by serving those storage bins with “lit” light modules.

According to some embodiments of the present invention, the light module includes two or more “lights” that allow multiple inventory specialists to concurrently serve a particular storage bin. In other words, the host computer can cause a particular light module to provide visual stimulation to multiple inventory specialists simultaneously (or approximately simultaneously) so that the inventory specialists can operate in parallel as opposed to sequentially or serially as in conventional systems.

In other embodiments of the present invention, the lights of the light module allow a single inventory specialist to concurrently service multiple orders from a particular storage bin. In other words, the host computer can cause a particular light module to provide visual stimulation regarding multiple orders to the single inventory specialist. In these embodiments, the single inventory specialist can serve orders in parallel.

According to various embodiments of the present invention, the host processor controls the light modules based on the inventory items included in the order as well as the inventory specialist assigned to service each order. The light modules direct the inventory specialist assigned to each order to the proper storages bins where the order can be serviced. The host computer may also control the light modules to specify how many inventory items the inventory specialist should service at each storage bin.

In one embodiment of the present invention, the light module includes a quantity indicator and two or more lights. In this embodiment, each light corresponds to a particular inventory specialist. This may be accomplished by assigning a light, either by its color or its position, to the particular inventory specialist. This may also be accomplished by assigning an order that is associated with one of the lights (e.g., a color code on the order matches a color of the light, etc.) to the particular inventory specialist.

In this embodiment of the present invention, the quantity indicator displays a quantity of inventory items that are to be serviced from that storage bin. When multiple lights on the light module are lit (or otherwise actuated), the quantity indicator rotates its display in a coordinated fashion with the lights to convey how many inventory items are associated with each of the inventory specialist and/or orders.

In another embodiment of the present invention, the light module includes two or more quantity indicators each assigned to an inventory specialist. This may be accomplished by assigned each inventory specialists to a quantity indicator based on its position in the light module, the color of its lights (LEDS, LCDS, backlights, etc.), the color of its face or housing, etc. This may also be accomplished by assigning an color-coded order to the inventory specialist as described above.

In another embodiment of the present invention, the light module includes a single quantity indicator whose display rotates through various colors (and corresponding numbers) each of which is assigned to an inventory specialist in manners similar to those described above.

According to various embodiments of the present invention, the light modules may also include various mechanisms by which the inventory specialists may indicate completion of service with regard to each inventory item in the order. By way of example and not of limitation, the light module may include a button associated with the lights and/or quantity indicators that can be depressed once the inventory item has been serviced. Once the inventory item has been serviced, the lights and/or quantity indicators associated with that inventory item and that inventory specialist are deactivated.

According to various embodiments of the present invention, host computer two or more orders that each include a similar inventory item. For each order, the host computer determines which light module corresponds to the inventory item. In some embodiments, the host computer assigns each order to a particular inventory specialist. For each order, the host computer forwards information that causes the light module to provide distinct visual stimulation so that multiple inventory specialists can concurrently service their assigned orders. In some embodiments, this visual stimulation may include or incorporate quantity information as described above.

One feature of the present invention is that multiple inventory specialists can concurrently service their respective orders at each storage bin.

Another feature of the present invention is that a single inventory specialist can concurrently service multiple orders at each storage bin.

Other features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a multi-user directed light inventory system according to one embodiment of the present invention.

FIG. 2 illustrates a light module according to one embodiment of the present invention.

FIG. 3 illustrates a light module according to another embodiment of the present invention.

FIG. 4 illustrates a light module according to yet another embodiment of the present invention.

FIG. 5 illustrates an operation of one embodiment of the present invention.

### DETAILED DESCRIPTION OF THE PREFERRED EMBODIMENTS

Conventional directed light inventory systems, also referred to as “pick-to-light” inventory systems, employ modules that illuminate, and in some instances provide quantity information, to direct an inventory specialist to one or more storage bins where inventory items are or should be located.

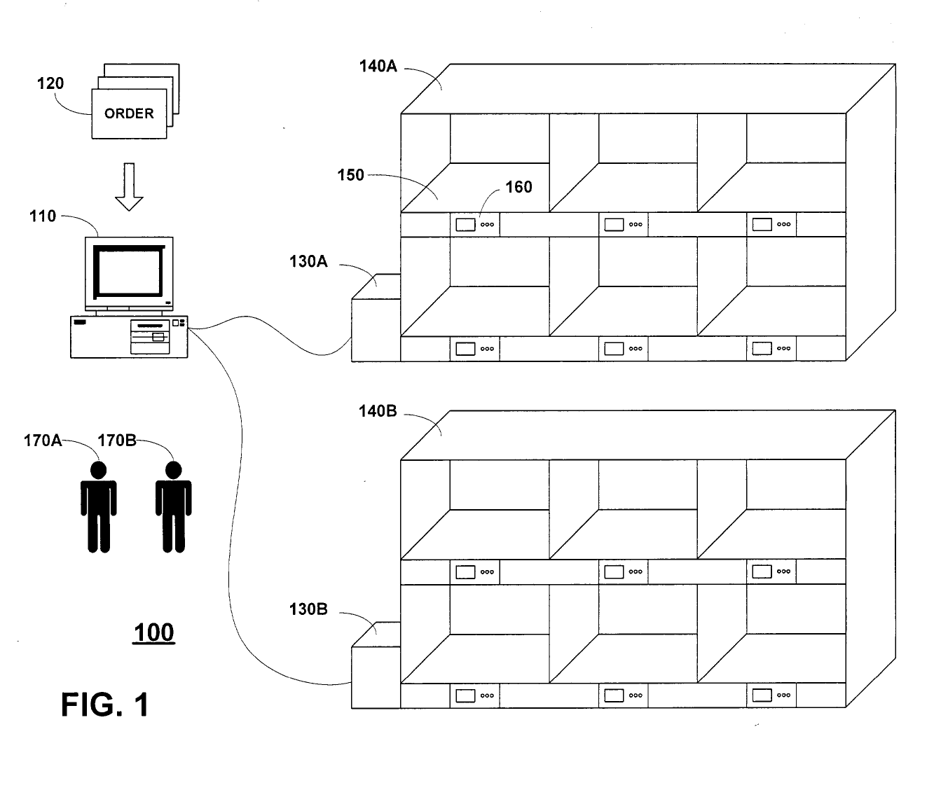

The present invention is directed to a multi-user directed light inventory system. FIG. 1 illustrates a multi-user directed light inventory system 100 according to one embodiment of the present invention. In this embodiment, inventory system 100 includes a host processor coupled via a communication channel to one or more zone controllers 130 (illustrated in FIG. 1 as a zone controller 130A and a controller 130B). Each zone controller 130 is likewise coupled via a communication channel to a plurality of light modules 160 each associated and co-located with a particular storage bin 150 in a zone 140 of storage bins. Zone 140 is illustrated as a rack of storage bins 150, although this is not necessary as would be apparent. Each storage bin 150 stores a quantity of inventory items having a unique identifier in inventory system 100. This unique identifier may, for example, correspond to a SKU number as would be apparent.

According to one embodiment of the present invention, host computer 110 maintains an “address” that corresponds to a particular light module 160 that is co-located with a particular storage bin 150 within a particular zone 140 (if more than one zone exists) where each inventory item may be found. As would be apparent, this address may be indexed based on the unique identifier for each inventory item.

According to the present invention, host computer 110 manages a plurality of orders 120 that must be serviced by inventory specialists 170 (illustrated in FIG. 1 as a inventory specialist 170A and an inventory specialist 170B) within inventory system 100. As would be apparent, host computer 110 receives an order 120 from another computer, a magnetic or optical medium, key entry, voice processing system, or other data and/or information transfer mechanism as would be apparent.

Host computer 110 determines which light modules 160 correspond to each of the inventory items included in each order 120 based on their location within a particular zone 140 and/or storage bin 150. Host computer 110 forwards information directly to light modules 160 or indirectly to light modules 160 through zone controllers 130 (and/or subcontrollers not illustrated) as would be apparent.

As discussed above, conventional inventory systems require that each order be serviced sequentially. However, according to the present invention, inventory system 100 allows a plurality of orders 120 to be processed in parallel either by multiple inventory specialists 170 each concurrently servicing a single order 120 or a single inventory specialist 170 concurrently servicing multiple orders 120. The present invention is henceforth described with regard to multiple inventory specialists 170 each concurrently servicing single orders. Adaptation to a single inventory specialist 170 servicing multiple order or some combination thereof will become apparent from the following description.

According the present invention, host processor 110 forwards light information to a corresponding light module 160 not only based on the inventory items included in each order 120, but also based on which inventory specialist 170 is assigned to service that order 120. Light module 160 responds by providing light indicia, or other form of visual stimulation, so that an appropriate one of inventory specialists 170 may service order 120. In some embodiments of the present invention, host processor may also forward quantity information to the corresponding light module 160 so that the appropriate inventory specialist 170 may service a proper number of inventory items with storage bin 150.

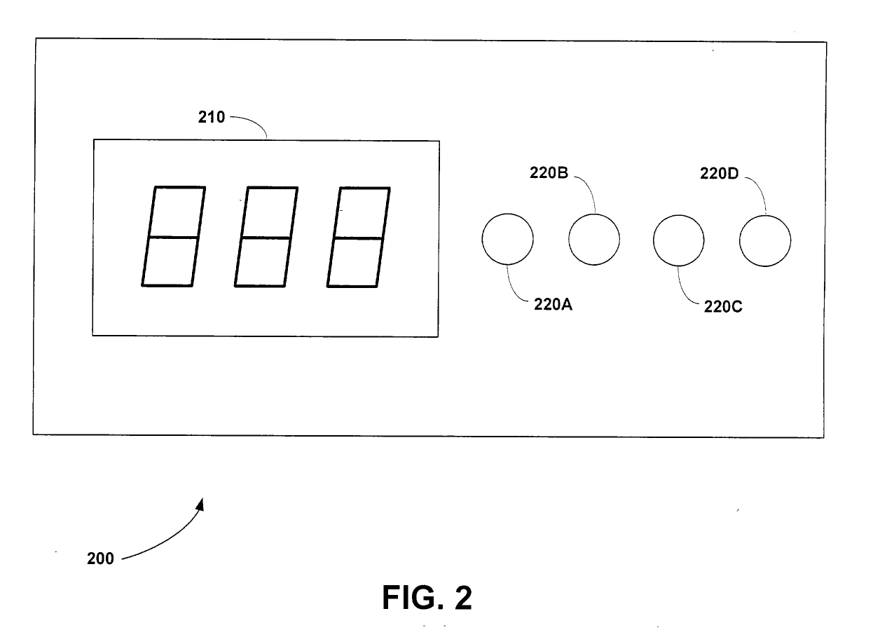

FIG. 2 illustrates a light module 200 according to one embodiment of the present invention. Light module 200 includes at least one quantity indicator 210 and a plurality of lights 220 (illustrated in FIG. 2 as a light 220A, a light 220B, a light 220C, and a light 220D). While described herein as a “light,” light 220 may correspond to any form of light indicia or visual stimulation capable of directing inventory specialists 170 to appropriate storage bins 150.

According to this embodiment of the present invention, each light 220 is associated with a particular inventory specialist 170. The embodiment illustrated in FIG. 2 allows four inventory specialists 170 to concurrently service four orders 120. In other embodiments of the present invention, fewer or greater numbers of lights 220 may be incorporated into light module 200 to allow a corresponding number of inventory specialists 170 to concurrently service orders 120 as would be apparent.

In one embodiment of the present invention, inventory specialists 170 may be assigned a particular light 220 based on its position on light module 200. In other words, for a particular order, time period, shift, permanent basis, etc., a particular inventory specialist 170 may be assigned the particular light 220 located at the position occupied by light 220B for example. For example, a particular inventory specialist 170 may be assigned the particular light 220 located at the position occupied by light 220C for example.

In another embodiment of the present invention, inventory specialists 170 may be assigned a particular light 220 based on a color of the particular light 220. This color may be the color of light 220 itself or of a housing or face of the light 220. For example, in some embodiments, a particular inventory specialist 170 may be assigned a red light 220. In other embodiments, a corresponding color code on order 120 may indicate to the particular inventory specialist 170 as to which color of light 220 to use. Lights 220 may be manufactured in a variety of colors as would be apparent.

In the embodiments thus described with regard to FIG. 2, quantity indicator 210 displays a quantity of inventory items associated with that particular order 120 and rotates its display through each of the orders in some fashion. In one embodiment of the present invention, one of lights 220 changes its state relative to the other lights 220, i.e., flashes, blinks, changes color or intensity, etc., when the quantity associated with that one light 220 is displayed. In another embodiment of the present invention, the color of the display could change to match that of one of lights 220 when its associated quantity is displayed. Other mechanisms for associating a displayed quantity with one of lights 220 are available as would be apparent. For example, additional lights or indicators could be used. According to these embodiments, the change of state allows each of lights 220 to provide visual stimulation for multiple orders simultaneously while still conveying quantity information.

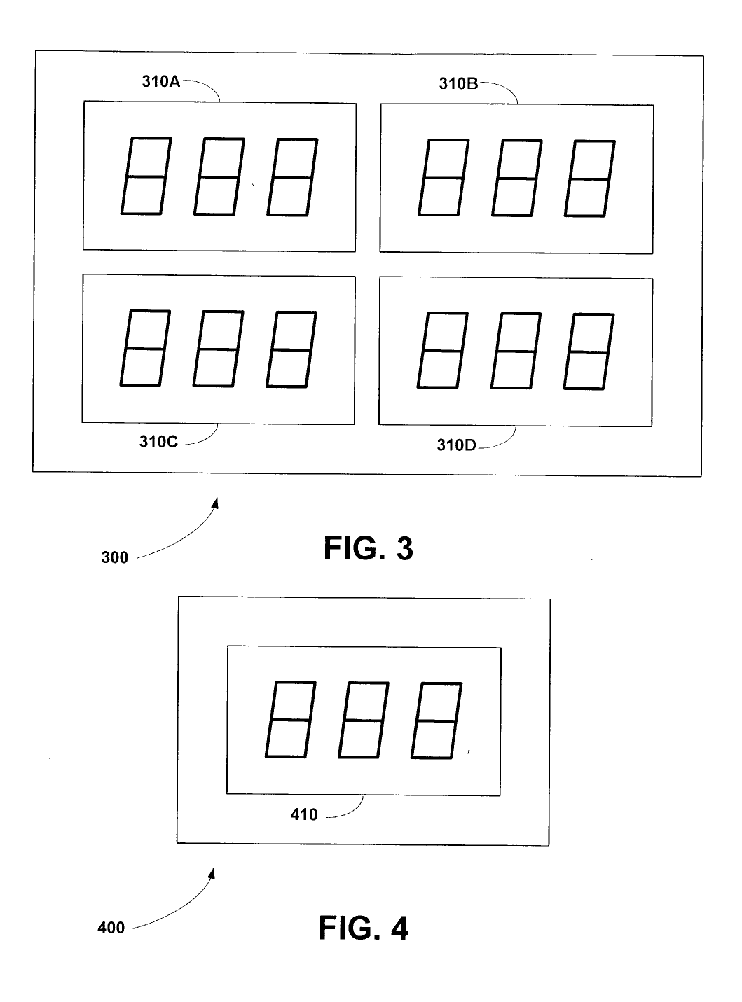

FIG. 3 illustrates a light module 300 according to one embodiment of the present invention. Light module 300 includes a plurality of quantity indicators 310 (illustrated in FIG. 3 as a quantity indicator 310A, a quantity indicator 310B, a quantity indicator 310C, and a quantity indicator 310D). According to the present invention, each quantity indicator 310 corresponds to a particular inventory specialist 170. The embodiment illustrated in FIG. 3 allows four inventory specialists 170 to concurrently service four orders 120. In other embodiments of the present invention, fewer or greater numbers of quantity indicators 310 may be incorporated into light module 300 to allow a corresponding number of inventory specialists 170 to concurrently service orders 120 as would be apparent.

In this embodiment of the present invention, light module 300 receives both light information and quantity information from host processor 110. Light module 300 uses this information to provide light indicia and to display a number on one of quantity indicators 310 corresponding to order 120 to a particular one of inventory specialist 170. In this embodiment, the light indicia and the displayed number may be one in the same as would be apparent.

In various embodiment of the present invention, inventory specialists 170 may be assigned a quantity indicator 310 based on its position, a color of its lights (LEDS, LCDS, backlights, etc.), a color of its face or housing, etc., as described above with regard to light module 200. In other embodiments, a corresponding color code on order 120 may indicate to the particular inventory specialist 170 which color of quantity indicator 310. Quantity indicators 220 may be manufactured in a variety of colors as would be apparent.

FIG. 4 illustrates a light module 400 according to another embodiment of the present invention. Light module 400 includes at least one quantity indicator 410. According to this embodiment of the present invention, a display of quantity indicator 410 rotates through various colors each of which corresponds to a particular inventory specialist 170. The embodiment illustrated in FIG. 4 allows for several inventory specialists 170 to concurrently service orders 120 based on a number of colors that can be discriminated by inventory specialists 170 viewing quantity indicator 410 and/or a number of colors available for the LEDs, backlighting, etc., of quantity indicator 410.

With regard to any of the embodiments of the present invention, light modules 200, 300, 400 may also include various mechanisms by which inventory specialists 170 may indicate completion of the servicing of their corresponding order. By way of example and not of limitation, light module 200 may include a button (not illustrated) associated with each of lights 210 that inventory specialist 170 depresses once he has completed his servicing of his order 120 as would be apparent. Once inventory specialist 170 completes servicing the corresponding storage bin 150, light module 160 forwards completion information to host processor 110 and turns off any lights and/or quantity indicators (depending on which embodiments is used) as would be apparent thereby indicating that no further inventory items are to be serviced from that storage bin 150 for that particular order 120.

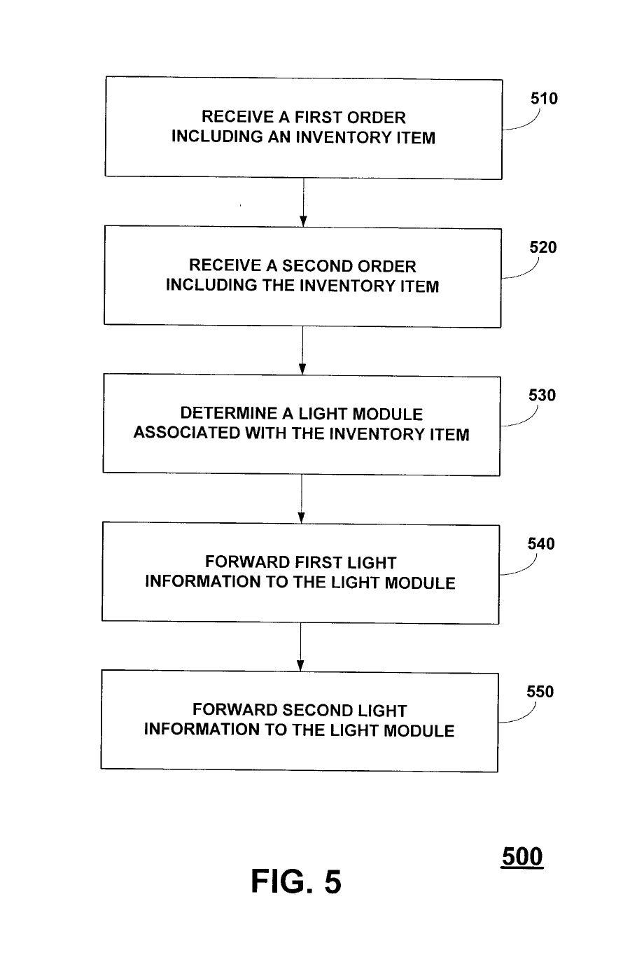

FIG. 5 illustrates a flow diagram illustrating an operation 500 of inventory system 100 according to one embodiment of the present invention. In an operation 510, host computer 110 receives a first order 120 including an inventory item. In an operation 520, host computer 110 receives a second order 120 including the same inventory item. In an operation 530, host computer 110 determines which light module 160 corresponds to the inventory item included in the first and second order 120. Operation 530 could be accomplished simultaneously for both orders or sequentially, i.e., at one time for the first order and at another time for the second order, as would be apparent.

In an operation 540, host computer 110 forwards light information, and in some embodiments of the present invention, quantity information, for the first order to the particular light module 160. This light information corresponds to a particular one of inventory specialists 170 who will service the first order; and this quantity information corresponds to a number of the inventory item included in the first order.

In an operation 550, host computer 110 forwards light information, and again in some embodiments of the present invention, quantity information, for the second order, to the particular light module 160. This light information corresponds to a particular one of inventory specialists 170 who will service the second order; and this quantity information corresponds to a number of the inventory item included in the second order.

In response to operations 540 and 550, light module 160 concurrently provides light indicia and/or corresponding quantity information to each inventory specialist 170, respectively, in accordance with various embodiments of light module 160 as described above.

While this invention has been described in a preferred embodiment, other embodiments and variations are within the scope of the following claims.

What is claimed is:

1. An inventory system comprising:
a host computer for managing a plurality of orders to be serviced; and
a light module that receives information from said host computer associated with said plurality of orders, said module having a plurality of light indicia, each light indicia associated with one of said plurality of orders so that said plurality of orders are concurrently serviced.

2. The inventory system of claim 1, wherein said plurality of orders are concurrently serviced by a plurality of inventory specialists.

3. The inventory system of claim 1, wherein said plurality of orders are concurrently serviced by a single inventory specialist.

4. The inventory system of claim 1, wherein said light module comprises a plurality of lights.

5. The inventory system of claim 1, wherein said light module further comprises a quantity indicator.

6. The inventory system of claim 1, wherein said light module comprises a plurality of quantity indicators.

7. The inventory system of claim 1, wherein said information comprises light information.

8. The inventory system of claim 1, wherein said information comprises quantity information.

9. The inventory system of claim 1, wherein said information comprises quantity information and light information.

10. An inventory system comprising:
a host computer for managing a plurality of orders to be serviced by a plurality of inventory specialists; and
a module having a plurality of lights and a quantity indicator, each of said plurality of lights associated with one of said plurality of inventory specialists, said module receiving light information and quantity information for each of said plurality of orders from said host computer, said plurality of lights responsive to said light information, said quantity indicator responsive to said quantity information,
whereby said plurality of orders are concurrently serviced by said plurality of inventory specialists.

11. A method for servicing orders comprising:
receiving a first order including an inventory item;
receiving a second order including the inventory item;
determining a light module associated with the inventory item included in the first order and the second order;
forwarding first light information to the light module, the first light information corresponding to a first inventory specialist; and
forwarding second light information to the light module, the second light information corresponding to a second inventory specialist,
whereby the first inventory specialist services the first order concurrently with the second inventory specialist servicing the second order.

12. The method of claim 11, further comprising:
determining a first inventory specialist to service the first order; and
determining a second inventory specialist to service the second order.

13. The method of claim 11, wherein the light module comprises first light indicia associated with the first inventory specialist and second light indicia associated with the second inventory specialist.

14. The method of claim 13, wherein the first light indicia comprises a first color associated with the first inventory specialist and wherein the second light indicia comprises a second color associated with the second inventory specialist.

15. The method of claim 13, wherein the first light indicia comprises a first light associated with the first inventory specialist and wherein the second light indicia comprises a second light associated with the second inventory specialist.

16. The method of claim 11, wherein the light module comprises first light indicia associated with the first order and second light indicia associated with the second order.

17. The method of claim 16, wherein the first light indicia comprises a first color associated with the first order and wherein the second light indicia comprises a second color associated with the second order.

18. The method of claim 16, wherein the first light indicia comprises a first light associated with the first order and wherein the second light indicia comprises a second light associated with the second order.

19. The method of claim 11, further comprising:
forwarding first quantity information to the light module; and
forwarding second quantity information to the light module.

20. A light module comprising:
a plurality of lights, each of said plurality of lights corresponding to one of an inventory specialist and an order;
a quantity indicator; and
an interface for receiving control information including light information and quantity information, said plurality of lights responsive to the light information and said quantity indicator responsive to the quantity information.
